(19) United States
(12) Patent Application Publication
(10) Pub. No.: US 2015/0315413 A1
(43) Pub. Date: Nov. 5, 2015

(54) METHOD AND KIT FOR SEALING ROOF PENETRATIONS

(71) Applicant: The Sherwin-Williams Company, Cleveland, OH (US)

(72) Inventor: Matthew Diggins, Elkhart, IN (US)

(21) Appl. No.: 14/699,551

(22) Filed: Apr. 29, 2015

Related U.S. Application Data
(60) Provisional application No. 61/986,197, filed on Apr. 30, 2014.
(60) Provisional application No. 62/118,266, filed on Feb. 19, 2015.

(51) Int. Cl. C09D 175/04; C09D 171/00; C09D 167/00

(52) U.S. Cl. CPC C09D 175/04; C09D 167/00; C09D 171/00

(57) ABSTRACT

A method and kit for forming a seal around a roof penetration is disclosed. The method comprises dispensing a one-part moisture curable sealant into pitch pan formed around a roof penetration. The one-part moisture curable sealant contains a polymer having non-terminal silane groups. The incorporation of non-terminal silane groups can provide for a greater number of crosslinking points than terminal silane groups. The non-terminal silane groups can be placed at specific points along the polymer backbone and the number of crosslinking points, or concentration of crosslinking units, can be controlled. Generally, as the crosslinking points can be provided along the polymer chain, the number of crosslinking points is increased, especially as compared to polymers only having terminal silane groups. Increasing the number of crosslinking points can result in improved elasticity and cure-through as compared with silyl-terminated polymers, in addition to other advantages.

### CROSS REFERENCE TO RELATED APPLICATIONS

This application claims priority to U.S. Application No. 61/986,197 filed Apr. 30, 2014, and U.S. Application No. 62/118,266 filed Feb. 19, 2015.

### TECHNICAL FIELD

Certain embodiments of the present invention relate to a method and kit for sealing around a roof penetration. More particularly, certain embodiments of the present invention relate to a method of sealing around a roof penetration comprising dispensing a sealant containing a polymer having non-terminal silane groups into a pitch pan disposed about the roof penetration.

### BACKGROUND

Roofs typically are constructed to include a water impervious upper layer to prevent water from penetrating the roof structure. Although different materials are used depending on the type of roof constructed, this waterproof layer or surface is generally referred to as a roof membrane.

Roofs often have one or more penetrations extending upwardly and physically penetrating or extending through the waterproof layer of the roof. These penetrations may include vents, pipes, conduits or support members. These elements pierce the waterproof layer of the roof and define potential leak paths for water to penetrate through the roof, causing damage to the structure. To prevent water from leaking or migrating through the waterproof layer at these points, special care must be taken to seal the hole created in the membrane by the penetrating element. Often, a pitch pan is disposed about the penetration and sealant is deposited within the pitch pan to achieve sealing.

### SUMMARY OF THE INVENTION

The invention provides for a method for forming a seal around a roof penetration. The method comprises dispensing a one-part moisture curable sealant into pitch pan formed around a roof penetration. The one-part moisture curable sealant contains a polymer having non-terminal silane groups. The incorporation of non-terminal silane groups can provide for a greater number of crosslinking points than terminal silane groups. The non-terminal silane groups can be placed at specific points along the polymer backbone and the number of crosslinking points, or concentration of crosslinking units, can be controlled. Generally, as the crosslinking points can be provided along the polymer chain, the number of crosslinking points is increased, especially as compared to polymers only having terminal silane groups. Increasing the number of crosslinking points can result in improved elasticity and cure-through as compared with silyl-terminated polymers, in addition to other advantages. While silyl-terminated polymers generally emit methanol during curing, polymers having non-terminal silane groups emit ethanol during curing.

An embodiment provides for a kit for forming a seal around a roof penetration. The kit comprises a one-part moisture curable sealant containing a polymer having non-terminal silane groups, and a strip for forming a container to receive the sealant. The kit may also include a container of adhesive for adhering the strip to the roof.

Features and advantages of the disclosure will be set forth in part in the description which follows and the accompanying drawings described below, wherein one or more embodiments of the disclosure is described and shown, and in part will become apparent upon examination of the following detailed description taken in conjunction with the accompanying drawings.

### BRIEF DESCRIPTION OF THE DRAWINGS

FIG. 1 is a cross section of a pipe extending through a roof penetration sealed with a pitch pan and sealant of the claimed invention.

FIGS. 2A, 2B, 2C, 2D, and 2E are a schematic drawing showing the method of the claimed invention and using a kit of the claimed invention.

### DETAILED DESCRIPTION OF THE INVENTION

A method for forming a seal around a roof penetration comprises dispensing a one-part moisture curable sealant into pitch pan formed around a roof penetration. The one-part moisture curable sealant contains a polymer having non-terminal silane groups. Other ingredients may optionally be included in the sealant. Examples of other ingredients that may be included in the sealant include one or more plasticizers, fillers, antioxidants, ultraviolet absorbers, adhesion promoting agents, dehydrating agents, stabilizers, and colorants.

Conventional silane-terminated polymers typically include high molecular weight polypropylene glycol backbones. Some disadvantages of conventional silane-terminated polymers include restrictions on chain lengths, structural configurations, and polarities. Another disadvantage of conventional silane-terminated polymers is that they emit methanol during crosslinking. Methanol is toxic to the central nervous system and exposure to it should be minimized.

One example, incorporating a polymer having non-terminal silane groups into a one-part moisture-curable sealant used for forming a seal around a roof penetration results in improved physical properties and improved curing. The incorporation of non-terminal silane groups can provide for a greater number of crosslinking points than found in polymers having terminal silane groups, as the non-terminal silane groups can be placed at specific points along the polymer backbone and in greater numbers than terminal silane groups. Increasing the number of and/or customizing the placement of crosslinking points can result in improved elasticity and cure-through as compared with silyl-terminated polymers, in addition to other advantages. Further, one-part moisture-curable sealants incorporating non-terminal silane groups can have high resiliency, as well as improved resistance to heat and cold for longer life-cycles of sealants.

In addition or in the alternative, the one-part moisture-curable sealant comprises polymers having silane groups incorporated onto the polymer backbone as functional side groups not located in the terminal position, and may also be referred to as “silane-modified polymers.” The polymers may include at least several non-terminal silane groups per polymer chain. The silane groups may be placed at certain points along the polymer backbone in a targeted manner. This allows for greater control over the crosslinking density, crystallinity, and the polarity of the structures as compared with traditional silane-terminated polymers. The use of silane-modified polymers allows for a more homogenously linked polymer network and the reduction or elimination of free, unlinked polymer chains. Incorporating silane-modified polymers into a sealant for forming a seal around a roof penetration allows for a reduction or elimination of creep or shrinkage in the seal, resulting in an improved seal. Additionally, the initial tack is improved in sealants incorporating polymers having non-terminal silane groups. As compared to sealants formed using polymers having terminal silane groups, the initial tack of sealants formed using polymers having non-terminal silane groups is improved by from about 5% to about 25%.

Further in addition or in the alternative, one example provides for a sealant incorporating polymers having non-terminal silane groups wherein the polymer backbone may be selected from the group consisting of polyurethanes, polyethers (polyether alcohols), and polyesters. The silane-modified polymers or polymers having non-terminal silane groups according to this embodiment include two or more reactive silyl side groups, none of the silyl groups being in the terminal position relative to the polymer backbone. Suitable silane groups include but are not limited to alkoxysilyl groups. Examples of suitable silane-modified polymers that may be employed in the sealant are polyethers with alkoxysilyl groups. Other suitable polymers include polypropylene glycols with silane groups. Additional examples of suitable silane-modified polymers are the polymers available from Evonik Degussa GmbH under the TEGOPAC® trademark, such as the TEGOPAC® Seal 100, TEGOPAC® Bond 150, or TEGOPAC® Bond 250. (Tegopac is a registered trademark of Evonik Degussa GmbH.) Suitable silane-modified polymers are further described in US 2011046305 A1, U.S. Pat. No. 8,450,514 B2, which are assigned to Evonik Goldschmidt GmbH, and U.S. Pat. No. 8,883,932 B2, which is assigned to Evonik Degussa GmbH.

In certain embodiments, the polymer may have an average molecular weight of from about 12,000 g/mol to about 20,000 g/mol. In one example, the polymer may have an average molecular weight of about 16,000 g/mol. Providing for adequate length between individual crosslinking points will allow for maximum elongation of the polymer and good mechanical properties. Additionally, the crosslinking points provide tensile strength and promote curing. Therefore, it is desirable to employ a polymer having a concentration of crosslinking silyl units per polymer that is not so dense that it inhibits elongation, but is not so sparse that the tensile strength or curing is negatively affected. In one example, the concentration of crosslinking units per polymer is in the range of from about 3.5% to about 6.5% of crosslinking units per base polymer molecule. In another example, the concentration of crosslinking units per polymer is in the range of 3.5-4.5% of crosslinking units per base polymer molecule. The crosslinking units may be reactive alcoxysilylpropyl groups. An example of a suitable base polymer is polypropylene glycol (PPG). Suitable crosslinking units may be bifunctional or trifunctional. The crosslinking units may be statistically distributed over the length of the polymer chain in the concentrations specified above. The placement and location of the crosslinking units may also be controlled in forming polymers having non-terminal silane groups utilized in sealants for roof penetrations, and the crosslinking units are not located in the alpha- or omega-positions (non-terminal).

In an embodiment, employing polymers having non-terminal silane groups also allows for more thorough curing. In traditional sealants employing terminal silane groups, through-cure of thick layers (for example, greater than approximately 7 mm in thickness) has been problematic. The improved physical properties of the polymer including non-terminal silane groups allows for more thorough through-cure for thick layers (for example, thorough curing to about 9.5 mm in thickness or greater.) Thorough curing of thicker layers allows for improved results when utilizing the sealant of the present embodiment for filling pitch pans around roof penetrations according to the method of the present embodiment. For example, when utilizing the sealant of this embodiment, which incorporated the polymer having non-terminal silane groups, it is possible to fill joints or areas that are wider and deeper as compared to sealants incorporating silyl-terminated polymers. Polymers formed with non-terminal silane groups have improved elastic recovery as compared with polymers having terminal silane groups. Sealants incorporating non-terminal silane groups can achieve an elastic recovery of greater than 70%, which meets the ISO 11600 standard. Accordingly, the improved cure-through and elasticity are among the advantages to employing sealants according to the embodiments disclosed herein in forming seals around roof penetrations.

Curing may occur under dry or humid conditions but typically occurs under humid conditions. A catalyst may be included in the sealant to promote curing. It can be appreciated that as an embodiment provides a method for forming a seal around a roof penetration, curing may take place at typical outdoor temperatures above freezing. While silyl-terminated polymers generally emit methanol during curing, polymers having non-terminal silane groups emit ethanol during curing, thereby avoiding the emission of a toxic by-product.

The present disclosure is directed to a method of forming a seal around a roof penetration. In an embodiment, the method includes forming a pitch pan or container from a strip, (the terms “pitch pan” and “container” are used interchangeably in describing embodiments of the invention,) disposing the container about the roof penetration, and depositing sealant into the container to seal the roof penetration. The sealant is a one-part moisture-curable sealant containing a polymer having non-terminal silane groups. The sealant is capable of adhering to most metals such as aluminum, steel and galvanized steel, asphalt, concrete, cement, fiberglass, glass, wood, tile, ethylene propylene diene monomer (EPDM), primed thermoplastic polyolefin (TPO), primed polyvinyl chloride (PVC), vinyl, acrylonitrile butadiene styrene (ABS) and other common roofing and building materials. The sealant is further considered to be semi-self-leveling, meaning that it is capable of being applied by trowel for example, but will, without physical intervention, eliminate minor irregularities in the surface of the sealant to form a level surface.

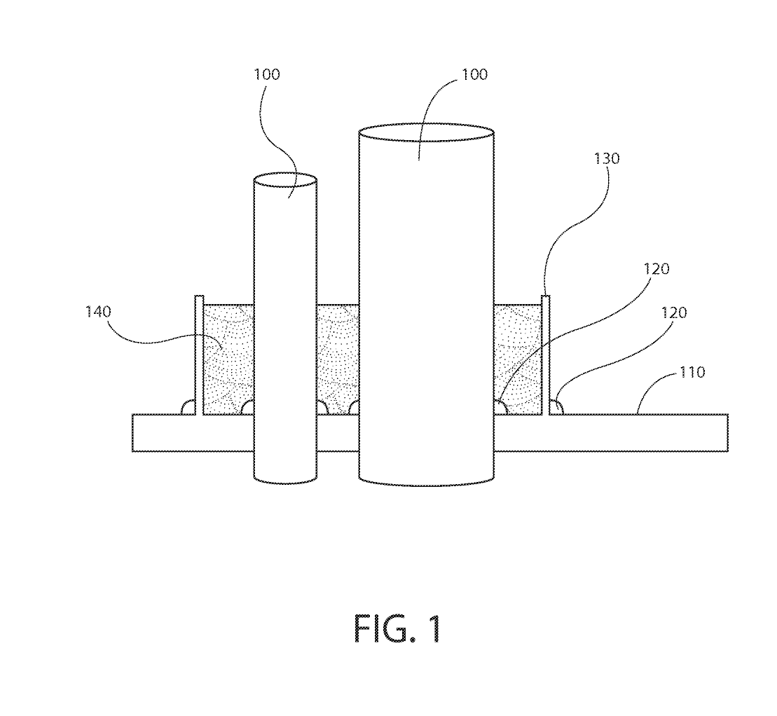

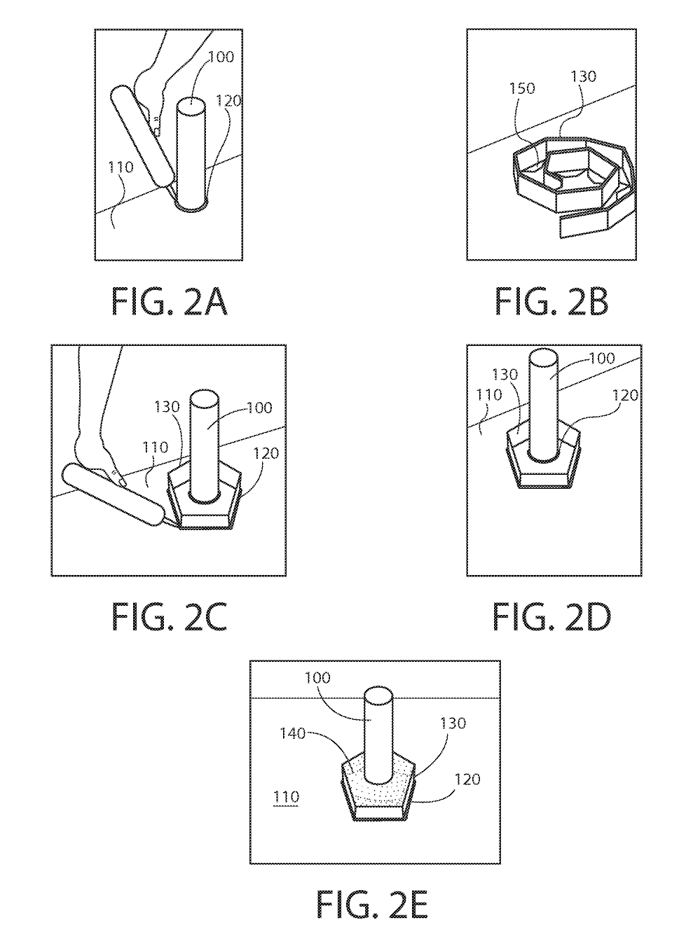

To seal a roof penetration, the pitch pan may be affixed, attached, or bonded to the roof in any suitable manner, and then filled with sealant. For example, FIG. 1 shows a cross section of a PVC pipe 100 extending through a roof substrate 110, where a pitch pan 130 surrounds the pipe 100, and is filled with a sealant 140 to seal the roof substrate 110. The present kit and method may also be used for roof penetrations made of materials other than PVC. FIGS. 2A through 2E illustrate a method that can be used to form the sealed roof penetration shown in FIG. 1. In FIGS. 2A through 2E, which is an ordered schematic drawing of a method of sealing a roof penetration, a pitch pan 130 is placed around the pipe 100 and is attached to the roof substrate 110. Next, a sealant or adhesive 120 may be used to seal the pitch pan 130 to the roof substrate 110. An adhesive 120 may also be used to seal the roof substrate 110 at the point where the pipe 100 extends through the roof substrate 110. The pitch pan 130 may be attached to the roof substrate 110 using adhesives or bonding agents, or may be fastened to the roof with any suitable fastener including screws, nails, or rivets. In an embodiment, the pitch pan may include flanges 150 for attaching the container to the roof about the roof penetration, as shown in FIG. 2B. In an embodiment, the pitch pan may be a continuous strip. In another embodiment, the pitch pan may be a strip that defines a plurality of panels positioned in a side-by-side manner, which may be bent or shaped as desired to form the container, as shown in FIG. 2B. The pitch pan or strip may comprise a metal or a polymer such ethylene propylene diene monomer (EPDM), thermoplastic polyolefin (TPO), or polyvinyl chloride (PVC) for example. In the case of TPO and PVC, it may be advantageous for the material to be primed prior to application of the sealant. The strip forms a container wherein the strip defines a wall of the container, said wall being substantially perpendicular to the roof when attached to the roof, as shown in FIGS. 2C and 2D. In FIG. 2E, once the pitch pan 130 is attached to the roof substrate 110, the pitch pan 130 is then filled with sealant 140, which is a one-part, moisture curable sealant containing a polymer having non-terminal silane groups, such as a polymer in the embodiments disclosed above, to seal the roof penetration. The sealant 140 may be poured directly into the pitch pan 130.

The present disclosure is also directed to a kit for forming a seal around a roof penetration. In an embodiment, the kit may comprise a strip for forming a container or a pitch pan around the roof penetration, and a one-part moisture curable sealant for dispensing into the pitch pan or container, the sealant including a polymer having non-terminal silane groups. Optionally, the kit may also include an adhesive or bonding agent for attaching the pitch pan to the roof about the roof penetration. As a further optional aspect, the kit may also include suitable fasteners for attaching the pitch pan to the roof, examples of which include screws, nails, or rivets. The pitch pan may further optionally include flanges for attaching the container to the roof about the roof penetration. In some examples, the strip may be continuous. In other examples, the strip may define a plurality of panels positioned in a side-by-side manner, which may be bent or shaped as desired to form the container. The strip may form a container wherein the strip defines a wall of the container, said wall being substantially perpendicular to the roof when attached to the roof. A one-part, moisture curable sealant containing a polymer having non-terminal silane groups, such as a polymer in the embodiments disclosed above, is then dispensed into the container to seal the roof penetration.

### EXAMPLES OF THE FORMULATION

### Examples 1 and 2

A sealant according to the claimed invention may comprise one or more alkoxysilyl-modified polyethers, such as TEGOPAC® Seal 100 or TEGOPAC® Bond 150, available from Evonik Industries AG, platicizers such as a phthalate, including diisododecyl phthalate (DIDP), diisononyl phthalate (DINP) or diisobutyl phthalate (DIBP) and the like, one or more pigments such as carbon black or titanium dioxide, and one or more fillers such as calcium carbonate. The alkoxysilyl-modified polyethers do not contain terminal silane groups. A catalyst such as dioctyl tin oxide or TIB KAT® 223 catalyst (TIB Chemicals) may be utilized. The sealant may also contain one or more thixotropic agents such as fumed silica and/or moisture scavengers such as silane-based scavengers. An example of a silane-based moisture scavenger is a vinyl trimethoxysilane. An adhesion promoter such as a diaminotrimethoxysilane may also be present.

In further examples, the filler may be a calcium carbonate a precipitated calcium carbonate, a surface-treated calcium carbonate, ground limestone or mixtures thereof. In one particular example, a surface-treated calcium carbonate may be stearate-treated and may be present in an amount of 20-52.5 percent by weight. In addition or in the alternative, the calcium carbonate may be a ground limestone in the amount of up to approximately 33 percent by weight. In further addition or alternative, the calcium carbonate may be a precipitated calcium carbonate present in an amount of approximately 5 percent by weight.

The sealant of the claimed invention may comprise the following components and amounts:

TABLE 1

| Description | Weight % |
|---|---|
| Plasticizer | 18% |
| Alkoxysilyl-modified polyether | 20-25% |
| Pigment | 1.4-2.0% |
| Precipitated calcium carbonate filler | 0-5% |
| Surface-treated calcium carbonate filler | 20-52.5% |
| Ground limestone filler | 0-32.9% |
| Moisture scavenger | 0.5% |
| Thixotropic agent | 0-0.7% |
| Adhesion promoter | 1.4% |
| Catalyst | 0.3-0.5% |

An exemplary process for forming the sealant of the claimed invention includes mixing plasticizer, alkoxysilyl-modified polyether, pigment and calcium carbonate. Heat is brought up to approximately one hundred seventy-five degrees Fahrenheit (175° F.), while in a vacuum. Mixing is continued for sixty (60) minutes. Then, the vacuum is broken with nitrogen. The water content is checked to reach six hundred sixty part-per-million (660 ppm) water content before proceeding. The mixture is then cooled to one hundred ten (110° F.), and placed under nitrogen. Moisture scavenger is added and mixed for 20 minutes before adding a thixotropic agent. Mixing is continued fifteen (15) minutes before adding an adhesion promoter. The resulting combination is mixed for another fifteen (15) minutes before adding the catalyst. Then, fifteen (15) minutes of additional mixing occurs. Finally, the vacuum is once again broken with nitrogen.

The properties of two examples (Examples 1 and 2) of a non-terminal silyl modified polyether were tested as provided in the table below. Comparative examples 1 and 2 are silane-terminated polyethers. The properties tested include adhesion to a variety of substrates largely according to test method ASTM C794-06 with the exception of the omission of a seven day immersion test and the use of stainless steel mesh instead of cloth. Briefly summarized, the adhesion test includes embedding a strip of stainless steel mesh in a thin layer of sealant, curing the sealant and then placing the sample in a tension-testing machine such that the embedded cloth is peeled back from the substrate at 180 degrees and measuring the force necessary to cause the separation of the sealant from the substrate and the nature of the separation. The amount of force necessary to pull the sample from the substrate is provided in pound force (lbf; 1 lbf=4.48 N (Newtons)). The failure mode is provided as a percentage of sample area that fails cohesively, resulting in the sealant tearing apart. A failure mode of 20C signifies a 20 percent cohesive failure. A 100 percent cohesive failure (100C) indicates that the sealant's internal (cohesive) strength is lower than the strength of the bond to the substrate surface and the sealant ruptures instead of releasing from the substrate. A 100 percent adhesive failure (release of the sealant from the substrate) is indicated by the designation 100A. The following properties were observed.

TABLE 2

| | Comparative | Comparative | | |
|---|---|---|---|---|
| | example 1 | example 2 | Example 1 | Example 2 |
| Density (lb/gal) | 9.16 | 12.73 | | 12.35 |
| Total weight solids (%) | 97.47 | 98.70% | | 99.22% |
| Viscosity at 5.0 rpm (T-C) | 35,000 | 56,800 | 90,000 | 96,000 |
| Low Temperature Flexibility | Pass | Pass | | Pass |
| Skin Time (internal) | 20 min | 30 min | 40 min | 50 min |
| Tack Free Time (ASTM) | 75 min | 60 min | 80 min | 90 min |
| Type “A” Hardness | 27 | 35 | 33 | Not tested |
| Tensile at Peak (psi) | 110.5 | 175.58 | 140 | Not tested |
| Elongation at Break (%) | 238.833 | 408.34 | 320 | Not tested |
| Material | Dry Adhesion (lbf/failure mode) | | | |
| ABS | 6.88/100c | 8.64/100c | Not tested | 6.35/100C |
| Aluminum | 10.47/100c | 10.06/100c | Not tested | 6.74/100C |
| Brick | 6.02/100c | 13.65/100c | Not tested | Substrate |
| | | | | broke |
| Concrete | 8.79/100c | 12.83/100c | Not tested | 7.48/100C |
| EPDM (Black) | 6.45/100c | 6.61/100c | 5.6/100C | 2.85/25C |
| EPDM (Black) Primed | Not tested | Not tested | 5.1/100C | 2.98/17.5C |
| Fiber Cement | 7.66/100c | 9.46/100c | Not tested | 6.42/100C |
| Fiberglass | 9.15/100c | 9.27/100c | Not tested | 7.08/100C |
| Galvanized Steel | 8.08/100c | 11.56/100c | Not tested | 6.57/100C |
| Glass | 10.03/100c | 12.48/100c | Not tested | 6.82/100C |
| Kynar | .37/100c | 8.80/80c | Not tested | 0.60/100A |
| Luan (Wood) | 9.01/100c | 11.20/100c | Not tested | 7.00/100C |
| Modified Bitumen | 2.53/100c | 1.28/50c | Not tested | 065/100A |
| PVC | 6.13/100c | 8.22/100c | 6.4/100C | 3.43/50C |
| Shingle | 3.91/100a | 6.79/100sf | Not tested | 5.14/97.5C |
| Steel | 8.69/100c | 10.76/100c | Not tested | 6.45/100C |
| Steel (Rusted) | 8.82/100c | 10.22/100c | Not tested | 6.65/100C |
| Tile | 9.97/100c | 11.98/100c | Not tested | 7.48/100C |
| TPO (Carlysle) | 2.88/100a | Fell Off | 0.7/100A | 0.17/100A |
| Vinyl | 8.19/100c | 10.58/100c | 7.1/100C | 5.75/100C |
| Vinyl (Primed) | Not tested | Not tested | 6.0/100C | 6.18/100C |
| Unprimed Pitch Pocket | 9.00/100c | Not tested | 7.4/100C | — |
| Primed Pitch pocket | 8.33/100c | Not tested | 7.2/100C | 6.57/100C |
| Unprimed White Epdm | 1.22/100a | Not tested | 4.1/100C | 2.2/75C |
| Primed White EPDM | 5.56/100c | Not tested | 4.2/100C | 3.34/75C |
| Primed TPO | 1.66/100a | 1.01/100a | 6.6/100C | 4.67/80C |
| Primed PVC | 3.49/100a | 5.14/80c | 6.5/100C | 5.13/100C |

### Example 3

A sealant according to the claimed invention was used to form a seal around a roof penetration. Pitch pans were formed around several test roof penetrations on several different substrates in different conditions. The pitch pans were secured to the substrates and then the pitch pans were filled with a sealant according to the claimed invention. Table 3 below outlines the conditions and substrates used for sealing the test roof penetrations.

TABLE 3

| | | | Surface | |
|---|---|---|---|---|
| | Substrate and Surface | Air | Temp. of | Relative |
| Sample | Prep | Temp. | Substrate | Humidity |
| A | PVC adhesion promoter | 80° F. | 80° F. | n/a |
| | applied to PVC conduit, | | | |
| | metal pan used over | | | |
| | elastomeric backing | | | |
| | applied to plywood | | | |
| B | Aged TPO substrate, | 60° F. | 65° F. | n/a |
| | prepared with TPO/PVC | | | |
| | primer | | | |
| C | Cleaned wood | 67° F. | 65° F. | 22% |
| D | Modified bitumen | 58° F. | 50° F. | 45% |
| E | EPDM cleaned with | 65° F. | n/a | n/a |
| | membrane cleaner | | | |

All of the test roof penetrations outlined in Table 3 above were sealed using a sealant according to the claimed invention. For all samples, adherence to metal and plastic pitch pans was excellent, the sealant remained watertight, and there was no shrinkage. All samples were tack-free and formed a skin, making them watertight, in under sixty minutes following application in which the pitch pan was filled with sealant. A skin was formed in at least one sample in fifteen minutes. In Sample A, above, sealant adherence to the metal pan and primed PVC conduit was excellent, however, it should be noted that the sealant adheres well to all tested substrates with the exception of unprimed PVC. A TPO adhesion promoter used on PVC will ensure optimal adherence to PVC. This is consistent with prior sealant formulations. Samples were primarily tested with pitch pans having a depth of two inches. One sample cured to a depth of one-eighth of an inch within twenty four hours, and cured at an average rate of one-quarter inch per week. For all samples, product application was favorable, and while the sealant is semi-self-leveling, it can be handled and troweled easily for repairs. Sample E was checked to verify curing and cure-through was complete.

While embodiments have been described in the foregoing description, such descriptions are considered exemplary and not restrictive in character, it being understood that only illustrative embodiments have been shown and described and that all changes and modifications that come within the spirit of the invention are desired to be protected. There are a plurality of advantages of the present disclosure arising from various features set forth in the description. It will be noted that alternative embodiments of the disclosure may not include all of the features described yet still benefit from at least some of the advantages of such features. Those of ordinary skill in the art may readily devise their own implementations of the disclosure and associated methods, without undue experimentation, that incorporate one or more of the features of the disclosure and fall within the spirit and scope of the present disclosure.

What is claimed is:

1. A method of forming a seal around a roof penetration, comprising: dispensing a one-part moisture curable sealant into a pitch pan formed around the roof penetration, said sealant containing a polymer having non-terminal silane groups, and allowing the sealant to cure.

2. The method according to claim 1 wherein the polymer contains no terminal silane groups.

3. The method according to claim 1 wherein the polymer backbone is selected from the group consisting of polyurethanes, polyethers, and polyesters.

4. The method according to claim 1 wherein the polymer backbone is a polypropylene glycol.

5. The method according to claim 1 wherein the polymer has a weight average molecular weight of from about 12,000 to about 20,000 g/mol.

6. The method according to claim 1 wherein the polymer has a weight average molecular weight of about 16,000 g/mol.

7. The method according to claim 1 wherein the polymer has an average concentration of crosslinking units of from about 3.5% to about 6.5%.

8. The method according to claim 1 wherein the polymer has an average concentration of crosslinking units of from about 3.5% to about 4.5%.

9. A kit for forming a seal around a roof penetration, comprising: a one-part moisture curable sealant for dispensing into a pitch pan formed around the roof penetration, said sealant containing a polymer having non-terminal silane groups, and a strip for forming a container to receive the sealant.

10. The kit according to claim 9 further comprising an adhesive for attaching the strip to the roof.

11. The kit according to claim 9 wherein the polymer contains no terminal silane groups.

12. The kit according to claim 9 wherein the polymer backbone is selected from the group consisting of polyurethanes, polyethers, and polyesters.

13. The kit according to claim 9 wherein the polymer backbone is a polypropylene glycol.

14. The kit according to claim 9 wherein the polymer has a weight average molecular weight of from about 12,000 to about 20,000 g/mol.

15. The kit according to claim 9 wherein the polymer has a weight average molecular weight of about 16,000 g/mol.

16. The kit according to claim 9 wherein the polymer has an average concentration of crosslinking units of from about 3.5% to about 6.5%.

17. The kit according to claim 9 wherein the polymer has an average concentration of crosslinking units of from about 3.5% to about 4.5%.
